(19) United States
(12) Patent Application Publication
(10) Pub. No.: US 2023/0008721 A1
(43) Pub. Date: Jan. 12, 2023

(54) CHARGING MANAGEMENT SERVER, CHARGING SYSTEM, CHARGING MANAGEMENT METHOD, AND NON-TRANSITORY COMPUTER READABLE MEDIUM

(71) Applicant: NEC Corporation, Tokyo (JP)

(72) Inventor: Sei Hoshino, Tokyo (JP)

(73) Assignee: NEC Corporaton, Tokyo (JP)

(21) Appl. No.: 17/850,262

(22) Filed: Jun. 27, 2022

(30) Foreign Application Priority Data
Jul. 7, 2021 (JP) 2021-113192

(51) Int. Cl. H02J 7/00

(52) U.S. Cl. CPC H02J 7/00034; H02J 7/0047

(57) ABSTRACT

A charging management unit of a charging management server acquires contact information of a first user who uses a charging unit for charging a traction battery of a vehicle. The charging management unit of the charging management server receives a first request indicating that a second user, who is a user different from the first user, wants to use the charging unit being used by the first user after the first user has finished using the charging unit. When the charging management unit of the charging management server receives the first request, it notifies the first user about the first request.

### INCORPORATION BY REFERENCE

This application is based upon and claims the benefit of priority from Japanese patent application No. 2021-113192, filed on Jul. 7, 2021, the disclosure of which is incorporated herein in its entirety by reference.

### TECHNICAL FIELD

The present disclosure relates to a charging management server, a charging system, a charging management method, and a non-transitory computer readable medium.

### BACKGROUND ART

Patent Literature 1 (Japanese Unexamined Patent Application Publication No. 2011-254644) discloses a reservation management server which transmits a notification electronic mail (email) to a user terminal of a user who owns a battery electric vehicle 30 minutes before charging of a traction battery of the battery electric vehicle is completed. According to this disclosure, since a current user can quickly move the battery electric vehicle as soon as the charging of the traction battery of this battery electric vehicle is completed, no inconvenience is imposed on another user who has a reservation for charging his/her traction battery after the current user.

Patent Literature 2 (Japanese Unexamined Patent Application Publication No. 2011-103721) discloses a server which transmits an email to a user terminal of a user who owns a battery electric vehicle to urge the user to exit from a charging space when the user continues to park his/her battery electric vehicle in the charging space even though charging of a traction battery of the battery electric vehicle is completed. According to this disclosure, it is possible to urge the user to exit from the charging space as soon as possible after the charging of the traction battery of his/her battery electric vehicle is completed. Further, in Patent Literature 2, the user will be charged in accordance with the period of time which elapses since he/she parked his/her battery electric vehicle in the charging space even after the charging is completed.

In both Patent Literature 1 and Patent Literature 2, a user of a battery electric vehicle is urged to exit from the charging space quickly after the charging of the battery electric vehicle is completed. In Patent Literature 2, a user is charged when he/she parks the battery electric vehicle for purposes other than the charging of it. This is an effective motivation for getting the user of the battery electric vehicle to exit from the charging space quickly.

### SUMMARY

An object of the present disclosure is to provide a technique for allowing a user who wants to use a charging unit after the current user of the charging unit to intentionally notify, by himself/herself, the current user that he/she intends to use the charging unit.

According to an example embodiment of the present disclosure, a charging management server includes: a first acquisition unit configured to acquire contact information of a first user who uses a charging unit for charging a traction battery of a vehicle; a first reception unit configured to receive a first request indicating that a second user wants to use the charging unit being currently used by the first user after the first user has finished using the charging unit, the second user being a user different from the first user; and a first notification unit configured to notify the first user about the first request when the first reception unit receives the first request. According to another example embodiment of the present disclosure, a charging management method includes: acquiring contact information of a first user who uses a charging unit for charging a traction battery of a vehicle; receiving a first request indicating that a second user wants to use the charging unit being currently used by the first user after the first user has finished using the charging unit, the second user being a user different from the first user; and notifying the first user about the first request when the first request is received.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a functional block diagram of a charging management server (a first example embodiment);

FIG. 2 is a schematic diagram of a charging system (a second example embodiment);

FIG. 3 is a functional block diagram of a charging unit (the second example embodiment);

FIG. 4 is a functional block diagram of a charging management server (the second example embodiment);

FIG. 5 is a flow of operations performed by the charging management server (the second example embodiment);

FIG. 6 is a flow of operations performed by the charging management server (the second example embodiment);

FIG. 7 is a diagram showing a display example of a web page including a charging waiting button (the second example embodiment);

FIG. 8 is a flow of operations performed by the charging management server (a third example embodiment); and

FIG. 9 is a diagram showing a display example of a web page including a transfer request button (the third example embodiment).

### EXAMPLE EMBODIMENT

### First Example Embodiment

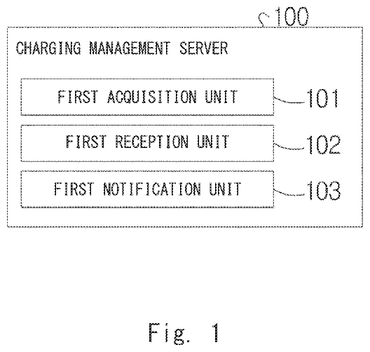

A first example embodiment will be described below with reference to FIG. 1. As shown in FIG. 1, a charging management server 100 includes a first acquisition unit 101, a first reception unit 102, and a first notification unit 103. The first acquisition unit 101 acquires contact information of a first user who uses a charging unit for charging a traction battery of a vehicle. The contact information is typically information indicating an email address, a telephone number, or an SNS account held by the first user.

The first reception unit 102 receives a first request indicating that a second user, who is a user different from the first user, wants to use the charging unit being used by the first user after the first user has finished using the charging unit. The first request may have an exclusive property of prohibiting a user other than the second user from using the charging unit being used by the first user after the first user has finished using the charging unit. On the other hand, the first request may have a non-exclusive property of permitting a user other than the second user to use the charging unit being used by the first user after the first user has finished using the charging unit.

When the first reception unit 102 receives the first request, the first notification unit 103 notifies the first user about the first request. When the contact information of the first user acquired by the first acquisition unit 101 includes an email address, the first notification unit 103 generates an email addressed to the email address and transmits the generated email. When the contact information of the first user acquired by the first acquisition unit 101 includes a telephone number, the first notification unit 103 generates a short message addressed to the telephone number and transmits the generated short message. When the contact information of the first user acquired by the first acquisition unit 101 includes an SNS account, the first notification unit 103 generates a message addressed to the SNS account and transmits the generated message.

According to the above configuration, a user who wants to use a charging unit after the current user of the charging unit can intentionally notify, by himself/herself, the current user that he/she intends to use the charging unit. Specifically, a user, who wants to use a currently-used charging unit after the current user has finished using the charging unit, can urge the current user to exit from the charging space quickly after the charging of his/her vehicle is completed.

### Second Example Embodiment

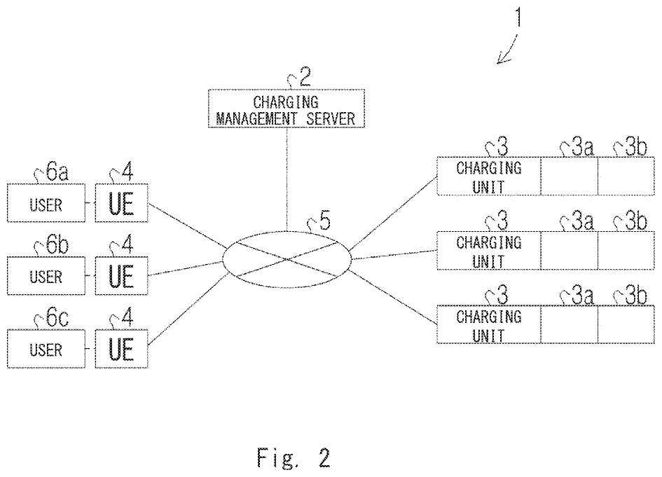

A second example embodiment will be described below with reference to FIGS. 2 to 7. FIG. 2 shows a schematic diagram of a charging system 1. The charging system 1 includes a charging management server 2, a plurality of charging units 3, and a plurality of User Equipments (UEs) 4.

Each of the charging units 3 is an apparatus for charging a traction battery of a vehicle. The vehicle is typically a battery electric vehicle or a Plug-in Hybrid Electric Vehicle (PHEV). The plurality of charging units 3 are typically deployed in service areas (SAs) and parking areas (PAs) provided in gas stations, large shopping malls, and along highways. In this example embodiment, for the sake of convenience of description, it is assumed that the plurality of charging units 3 are installed in a large shopping mall ABC. Each of the charging units 3 is provided with a charging space 3a for using the charging unit 3 and a standby space 3b for waiting to use the charging unit 3. The charging space 3a and the standby space 3b are spaces in which a vehicle can be parked. The standby space 3b may be omitted.

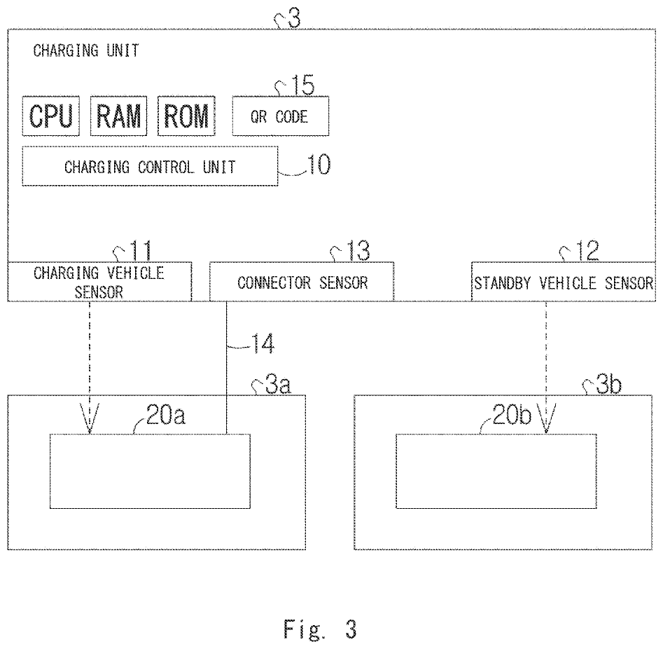

FIG. 3 shows a functional block diagram of each of the charging units 3. As shown in FIG. 3, the charging unit 3 includes a Central Processing Unit (CPU) serving as a central processing unit, a readable/writable Random Access Memory (RAM), and a read-only Read Only Memory (ROM). Further, when the CPU loads a control program stored in the ROM and executes the loaded program, whereby the control program causes hardware such as the CPU to function as a charging control unit 10. The charging control unit 10 controls charging of a traction battery of a vehicle connected to the charging unit 3.

The charging unit 3 further includes a charging vehicle sensor 11, a standby vehicle sensor 12, and a connector sensor 13. The charging vehicle sensor 11 detects that a vehicle 20a is parked in the charging space 3a. The standby vehicle sensor 12 detects that a vehicle 20b is parked in the standby space 3b. The connector sensor 13 detects that the vehicle 20a parked in the charging space 3a is connected to the charging unit 3 through a power transmission cable 14.

The charging unit 3 is typically connected to the charging management server 2 through a Wide Area Network (WAN) 5, such as the Internet, so that they can communicate with each other in a bidirectional manner.

A printed matter of a QR code 15 (registered trademark) is disposed in each of the charging units 3. The QR code 15 includes URL information for connection to a website for charging a vehicle. The URL information includes the URL itself and parameters. The parameters include identification information for identifying the charging unit 3 the QR code 15 is disposed on.

Referring back to FIG. 2, the UEs 4 are mobile terminals respectively owned by users 6, and are typically smartphones that can be connected to the WAN 5. Various types of Web services related to use of the charging unit 3 are provided to each of the users 6 from the charging management server 2 through the UE 4 owned by the user 6. In the following description, for the sake of convenience, it is assumed that a plurality of users 6 include a first user 6a, a second user 6b, and a third user 6c. The first user 6a, the second user 6b, and the third user 6c are different users. Each of the UEs 4 is configured so that it can communicate with the charging management server 2 though the WAN 5 in a bidirectional manner.

The charging management server 2 manages the plurality of charging units 3. The charging management server 2 is connected to the WAN 5. Further, the charging management server 2 has a function as a Web server that provides a Web service (the website for charging a vehicle) to each of the UEs 4. The charging system 1 may include a Web server capable of communicating with the charging management server 2 in a bidirectional manner in addition to the charging management server 2. That is, the function of the charging management server 2 may be implemented by the charging management server 2 alone or by a plurality of servers performing distributed processing.

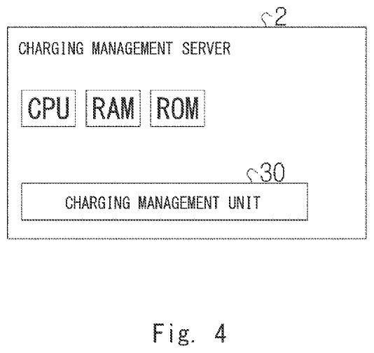

FIG. 4 shows a functional block diagram of the charging management server 2. As shown in FIG. 4, the charging management server 2 includes a Central Processing Unit (CPU) serving as a central processing unit, a readable/writable Random Access Memory (RAM), and a read-only Read Only Memory (ROM). Further, when the CPU loads a control program stored in the ROM and executes the loaded program, whereby the control program causes hardware such as the CPU to function as a charging management unit 30. The charging management unit 30 manages charging using the plurality of charging units 3 by transmitting and receiving various types of data to and from the plurality of UEs 4 and by transmitting and receiving various types of data to and from the plurality of charging units 3.

In this example embodiment, the charging management unit 30 functions as the first acquisition unit, the first reception unit, the first notification unit, a second acquisition unit, a second notification unit, a lock control unit, and a second reception unit.

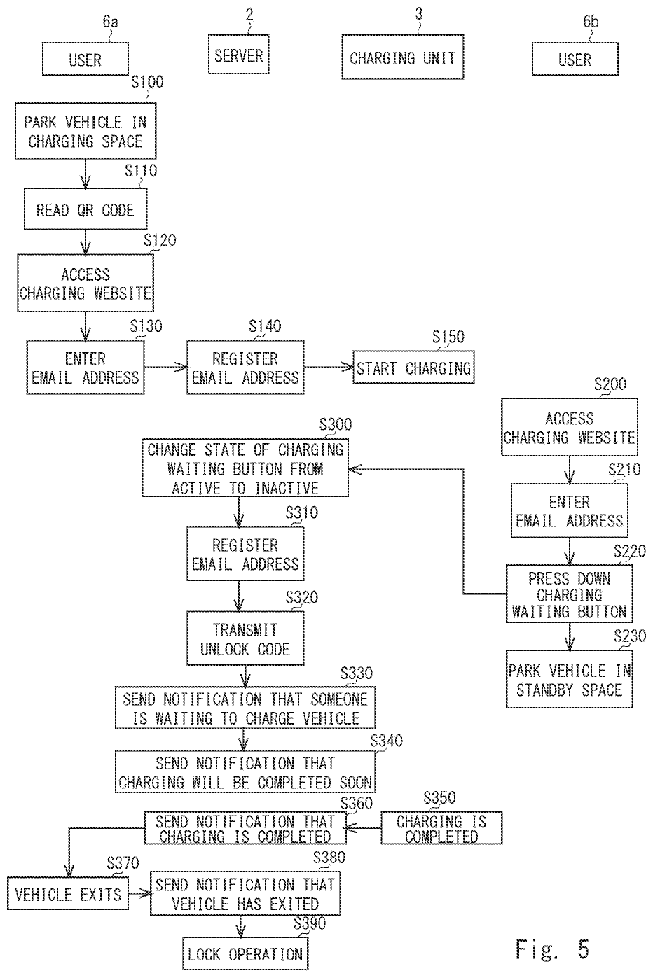

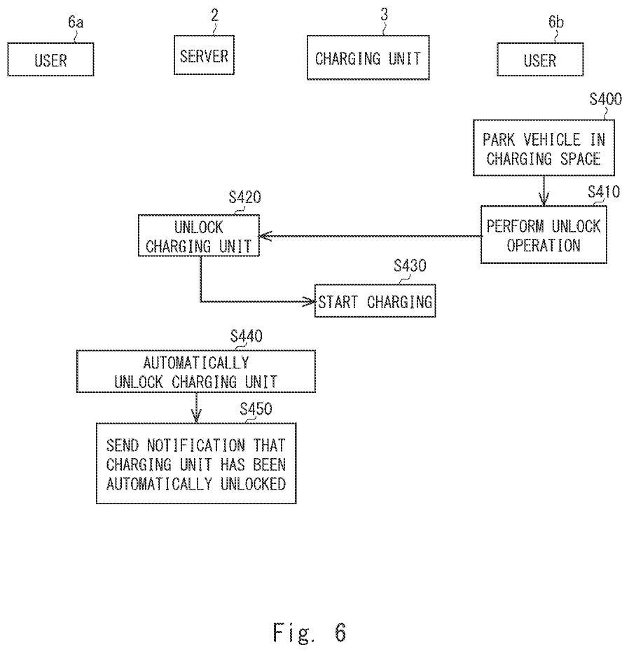

Operations performed by the charging management unit 30 will be described below with reference to FIGS. 5 and 6. Each of FIGS. 5 and 6 shows a flow of the operations performed by the charging management unit 30 of the charging management server 2. In FIGS. 5 and 6, operations performed by the first user 6a and the second user 6b and operations performed by the charging unit 3 are also shown in order to describe the operations performed by the charging management server 2. In FIGS. 5 and 6, it is assumed that the first user 6a uses a specific charging unit 3 among the plurality of charging units 3 installed in the large shopping mall ABC, and the second user 6b uses the same charging unit 3 after the first user 6a.

First, the first user 6a parks his/her own vehicle in the charging space 3a in order to charge a traction battery of his/her own vehicle by using the charging unit 3 (S100).

Next, the first user 6a reads the QR code 15 provided in the charging unit 3 by using the UE 4 (S110), and accesses the website for charging a vehicle provided by the charging management server 2 in accordance with URL information decoded from the QR code 15 (S120). Then the first user 6a enters his/her own email address on the website for charging a vehicle (S130). The email address is a specific example of contact information. The contact information may also be a telephone number or an SNS account held by the first user 6a.

The charging management unit 30 of the charging management server 2 associates the email address entered by the first user 6a with identification information of the charging unit 3 and registers them (S140).

Then, when the first user 6a connects the vehicle 20a to the charging unit 3 through the power transmission cable 14, the charging control unit 10 of the charging unit 3 starts charging the traction battery of the vehicle 20a (S150).

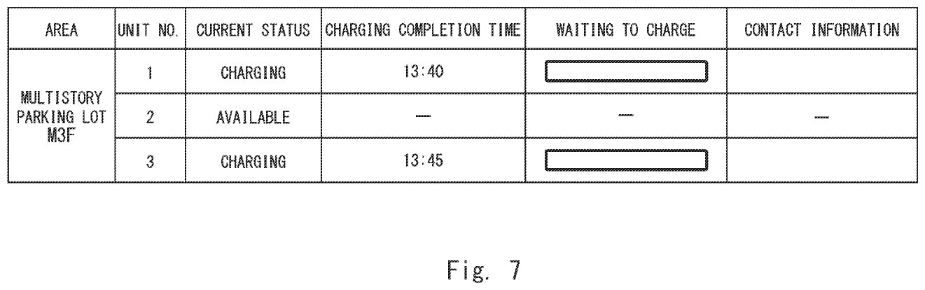

Meanwhile, the second user 6b who has arrived at the large shopping mall ABC after the first user 6a arrived there first accesses the website for charging a vehicle provided by the charging management server 2 (S200). Then, as shown in FIG. 7, a display of the UE 4 of the second user 6b displays the current status and charging completion time of each of the plurality of charging units 3. In the “current status” column, either “charging” or “available” is displayed. In the “charging completion time” column, the charging completion time of the charging unit 3 that is being charged is displayed. Further, for the charging unit 3 that is being charged, a charging waiting button and a text box for entering contact information are also displayed.

It is assumed here that the second user 6b wants to use the charging unit 3 of No. 1 that is currently in use. In this case, the second user 6b enters his/her own email address into the text box corresponding to the charging unit 3 of No. 1 (S210) and presses down the charging waiting button (S220). The email address is a specific example of the contact information. Then the second user 6b parks his/her vehicle in the standby space 3b (S230), enters the large shopping mall ABC, and starts shopping.

When the charging waiting button is pressed down (S220), the charging management unit 30 of the charging management server 2 changes the state of the charging waiting button corresponding to the charging unit 3 of No. 1 on the website for charging a vehicle from active to inactive (S300). This operation prevents another user from pressing down the charging waiting button corresponding to the charging unit 3 of No. 1 on the website for charging a vehicle.

The charging management unit 30 of the charging management server 2 associates the email address entered by the second user 6b with identification information of the charging unit 3 and registers them (S310). However, when the email address entered by the second user 6b has already been registered, the charging management unit 30 of the charging management server 2 may ignore this email address entered by the second user 6b.

Next, the charging management unit 30 of the charging management server 2 transmits an unlock code to the email address of the second user 6b (S320). The unlock code is a code for releasing, when the operation of the charging unit 3 is locked, the locked state of the operation of the charging unit 3. The unlock code is typically composed of 5 to 10 alphanumeric characters. However, instead of the alphanumeric characters, the unlock code may be a URL string including the unlock code as parameters.

Next, the charging management unit 30 of the charging management server 2 notifies the first user 6a that someone is waiting to charge his/her vehicle (S330). Specifically, the charging management unit 30 of the charging management server 2 transmits an email including a message “There is a person waiting to use the charger. Please therefore move your vehicle as soon as possible after charging is completed.” to the email address of the first user 6a.

Next, the charging management unit 30 of the charging management server 2 notifies the first user 6a and the second user 6b that charging will be completed soon, for example, 25 minutes after the charging unit 3 of No. 1 starts charging or five minutes before the charging completion time of the charging unit 3 of No. 1 (S340). Specifically, the charging management unit 30 of the charging management server 2 transmits an email including a message “Charging will be completed soon. Please therefore prepare to move your vehicle.” to the email addresses of the first user 6a and the second user 6b.

Next, when charging of the charging unit 3 of No. 1 is completed (S350), the charging management unit 30 of the charging management server 2 notifies the first user 6a and the second user 6b that charging is completed (S360). Specifically, the charging management unit 30 of the charging management server 2 transmits an email including a message “Charging is completed. Please therefore move your vehicle as soon as possible so that the next person can start using the charger.” to the email address of the first user 6a. Further, the charging management unit 30 of the charging management server 2 transmits an email including a message “Charging is completed. Please therefore prepare to move your vehicle.” to the email address of the second user 6b.

Next, the first user 6a of the vehicle 20a exits from the charging space 3a (S370). Then the charging management unit 30 of the charging management server 2 detects that the vehicle has exited from the charging space 3a via the charging vehicle sensor 11 of the charging unit 3, and notifies the second user 6b that the vehicle has exited (S380). Specifically, the charging management unit 30 of the charging management server 2 transmits an email including a message “The charging space is now available. Please move your vehicle to the charging space quickly.” to the email address of the second user 6b. Then the charging management unit 30 of the charging management server 2 locks the operation of the charging unit 3 (S390).

Next, referring to FIG. 6, the second user 6b advances his/her vehicle from the standby space 3b to the charging space 3a, and parks the vehicle in the charging space 3a (S400). At this time, the second user 6b connects the charging unit 3 to the vehicle via the power transmission cable 14. Then the second user 6b performs an unlock operation using the unlock code described in the email sent from the charging management unit 30 of the charging management server 2 (S410). Typically, the second user 6b accesses the website for charging a vehicle and enters the unlock code. By doing the above, the charging management unit 30 of the charging management server 2 releases the locked state of the operation of the charging unit 3 (S420). Then, charging performed by the charging control unit 10 of the charging unit 3 is started (S430).

When the locked state of the operation of the charging unit 3 has not been released even though a predetermined period of time (typically 15 minutes) has elapsed after the charging management unit 30 of the charging management server 2 has notified the second user 6b that the vehicle has exited (S380), the charging management unit 30 of the charging management server 2 automatically releases the locked state of the operation of the charging unit 3 (S440) and notifies the second user 6b that the charging unit has been automatically unlocked (S450). Specifically, the charging management unit 30 of the charging management server 2 transmits an email including a message “The charging unit has been automatically unlocked.” to the email address of the second user 6b. This operation prevents the second user 6b, who does not intend to use it, from exclusively using the charging unit 3. Thus, the rate of operation of the charging unit 3 can be increased.

The second example embodiment has been described above, and the above-described second example embodiment has the following features.

The charging management unit 30 (the first acquisition unit) of the charging management server 2 acquires contact information of the first user 6a who uses the charging unit 3 for charging the traction battery of the vehicle (S130, S140). The charging management unit 30 (the first reception unit) of the charging management server 2 receives a first request indicating that the second user 6b, who is a user different from the first user 6a, wants to use the charging unit being used by the first user 6a after the first user 6a has finished using the charging unit (S220, S300, S310). When the charging management unit 30 (the first reception unit) of the charging management server 2 receives the first request, the charging management unit 30 (the first notification unit) of the charging management server 2 notifies the first user 6a about the first request (S330). According to the above configuration, a user who wants to use the charging unit 3 after the current user of the charging unit 3 can intentionally notify, by himself/herself, the current user that he/she intends to use the charging unit 3. Specifically, the second user 6b, who wants to use the currently-used charging unit 3 after the first user 6a who is the current user of the charging unit 3 has finished using it, can urge the first user 6a to exit from the charging space 3a quickly after the charging of his/her vehicle is completed.

Note that “notifying the first user 6a about the first request” typically includes notifying the first user 6a about a message indicating the first request, such as a message indicating that the charging waiting button has been pressed down and a message indicating that there is a user waiting for the first user 6a to exit his/her vehicle from the charging space.

Further, the charging management unit 30 (the first reception unit) of the charging management server 2 does not receive a new first request after it receives the first request while the first user 6a is using the charging unit 3 (S300). According to the above configuration, it is possible to prevent the first user 6a from being repeatedly notified about the first request. This contributes to the improvement of a user experience.

Further, the charging management unit 30 (the second acquisition unit) of the charging management server 2 acquires the contact information of the second user 6b (S210, S310). The charging management unit 30 (the second notification unit) of the charging management server 2 notifies the second user 6b to start preparation to use the charging unit 3 a first period of time before completion of the charging performed by the charging unit 3 (S340). The “first period of time” is typically five minutes. According to the above configuration, the rate of operation of the charging unit 3 can be improved.

The charging management unit 30 (the lock control unit) of the charging management server 2 prohibits a user other than the second user 6b from using the charging unit 3 after the first user 6a has finished using the charging unit 3 (S390). According to the above configuration, the second user 6b can enjoy shopping or the like without any feeling of anxiety until the charging unit 3 becomes available.

The charging management unit 30 (the lock control unit) of the charging management server 2 may prohibit a user other than the second user 6b from using the charging space 3a for using the charging unit 3, thereby prohibiting the user other than the second user 6b from using the charging unit 3. In this case, for example, a gate apparatus that restricts vehicles from entering the charging space 3a is installed between the charging space 3a and the standby space 3b, and by controlling this gate apparatus, the use of the charging unit 3 is indirectly locked.

Further, when the second user 6b does not start using the charging unit 3 during a period from when the second user 6b is enabled to start using the charging unit 3 to when a second period of time has elapsed, the charging management unit 30 (the lock control unit) of the charging management server 2 permits a user other than the second user 6b to use the charging unit 3 (S440). According to the above configuration, the rate of operation of the charging unit 3 can be improved.

### Third Example Embodiment

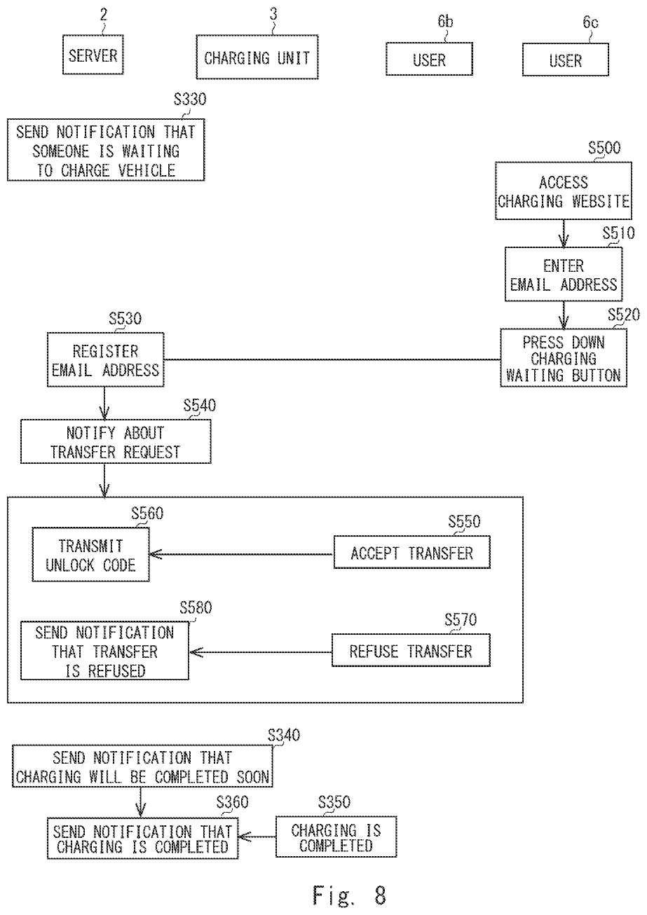

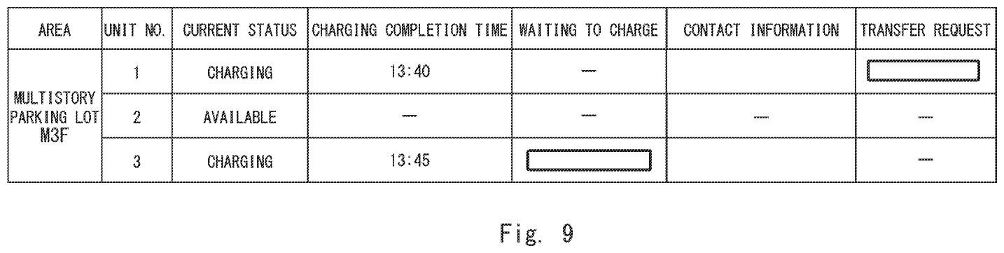

Next, a third example embodiment will be described with reference to FIGS. 8 and 9. This third example embodiment will be described below with a focus on differences between it and the second example embodiment, and descriptions of the third example embodiment which are the same as those of the second example embodiment will be omitted.

In the second example embodiment, as shown in FIG. 5, pressing down the charging waiting button (S220) corresponds to making a reservation for using the currently-used charging unit 3 after the current user has finished using it (S390). In this example embodiment, the aforementioned reservation can be transferred from one user to another user.

FIG. 8 shows a flow of operations performed by the charging management unit 30 of the charging management server 2. As shown in FIG. 8, when the charging waiting button is pressed down (S220 in FIG. 5), the charging management unit 30 notifies the first user 6a that someone is waiting to charge his/her vehicle (S330).

In this state, the third user 6c arrives at the large shopping mall ABC and desires to charge the traction battery. In this case, the third user 6c first accesses the website for charging a vehicle provided by the charging management server 2 (S500). Then, as shown in FIG. 9, the display of the UE 4 of the third user 6c displays the current status and charging completion time of each of the plurality of charging units 3. As shown in FIG. 9, a transfer request button is displayed in the transfer request column corresponding to the charging unit 3 of No. 1. Further, it is assumed that the third user 6c wants to use the charging unit 3 of No. 1. In this case, the third user 6c enters his/her own email address into the text box in the contact information column corresponding to the charging unit 3 of No. 1 (S510) and presses down the transfer request button (S520).

When the third user 6c presses down the transfer request button (S520), the charging management unit 30 of the charging management server 2 associates the email address entered by the third user 6c with the identification information of the charging unit 3 and registers them (S530).

Next, the charging management unit 30 of the charging management server 2 notifies the second user 6b about a transfer request (S540). Specifically, the charging management unit 30 of the charging management server 2 transmits an email including a message “There is a person who is in a hurry to use the charger, and could you therefore transfer your turn (i.e., reservation) for using the charger to this person?” to the email address of the second user 6b.

When the second user 6b accesses the website for charging a vehicle and presses down a transfer approval button in response to this message (S550), the charging management unit 30 of the charging management server 2 transmits an unlock code to the email address of the third user 6c (S560). The unlock code which the charging management unit 30 transmits to the email address of the third user 6c may be the same as or different from the unlock code which the charging management unit 30 has transmitted to the email address of the second user 6b. In the latter case, it is possible to restrict the second user 6b from using the charging unit 3 of No. 1.

On the other hand, when the second user 6b accesses the website for charging a vehicle and presses down a transfer refusal button in response to the above message (S570), the charging management unit 30 of the charging management server 2 transmits a notification that the transfer is refused to the email address of the third user 6c (S580).

When the transfer request is accepted by the second user 6b, the charging management unit 30 of the charging management server 2 notifies the first user 6a and the third user 6c that charging will be completed soon (S340). Further, when charging of the charging unit 3 of No. 1 is completed (S350), the charging management unit 30 of the charging management server 2 notifies the first user 6a and the third user 6c that charging is completed (S360).

As described above, by making it possible to transfer a reservation for using the charging unit 3 from one user to another user, for example, a user who needs to leave the large shopping mall ABC early can arrange to have another user who has sufficient time to spare to transfer his/her reservation to him/her.

Further, when the second user 6b is slow to move the vehicle parked in the standby space 3b to the charging space 3a even though the charging space 3a is empty since charging is completed, another user's use of the charging unit 3 will be prevented. Therefore, by enabling another user, i.e., the third user 6c, to ask the second user 6b whether or not the second user 6b can transfer his/her reservation to the third user 6c, the second user 6b can continue shopping without being interrupted and the third user 6c can immediately start using the charging unit 3 of No. 1.

In short, the charging management unit 30 (the second reception unit) of the charging management server 2 receives a second request indicating that the third user 6c, who is a user different from the first user 6a and the second user 6b, wants to use the charging unit 3 being used by the first user 6a after the first user 6a has finished using the charging unit 3 (S520). When the charging management unit 30 (the second reception unit) of the charging management server 2 receives the second request, the charging management unit 30 (a third notification unit) of the charging management server 2 notifies the second user 6b about the second request (S540). When the second user 6b accepts the second request, the charging management unit 30 (the lock control unit) of the charging management server 2 permits the third user 6c to use the charging unit 3. According to the above configuration, the rate of operation of the charging unit 3 can be improved.

The preferred first to third example embodiments according to the present disclosure have been described above, and the above-described example embodiments can be changed, for example, as follows without departing from the scope and spirit of the present disclosure.

That is, in the above-described second example embodiment, the second user 6b accesses the website for charging a vehicle (S200), presses down the charging waiting button (S220), and then parks his/her vehicle in the standby space 3b (S230). However, only when the standby vehicle sensor 12 detects that a vehicle is parked in the standby space 3b, the corresponding charging waiting button may be activated on the website for charging a vehicle. That is, the charging management unit 30 (the first reception unit) of the charging management server 2 receives the first request only when the vehicle 20b is present in the standby space 3b that is provided adjacent to the charging space 3a for using the charging unit 3. According to this configuration, it is possible to prevent a user who has not arrived at the large shopping mall ABCs from pressing down the charging waiting button in advance or unnecessarily.

Further, in the above-described second example embodiment, the URL of the website for charging a vehicle is opened to the public on the Web, and thus users who are not actually at the large shopping mall ABC can access the website for charging a vehicle. However, instead of the above, the URL of the website for charging a vehicle may be posted only in the large shopping mall ABC. According to this configuration, it is possible to prevent the charging waiting button from being pressed down unnecessarily.

Further, in the second example embodiment, when the charging waiting button or the transfer request button is operated a plurality of times in a short period of time from the UE 4 of which the IP address is the same each time, the charging management unit 30 of the charging management server 2 may ignore the second and subsequent operations.

Further, in the third example embodiment, in addition to a reservation being transferrable from one user to another user, a reservation can be purchased and sold by users.

Further, in the second and the third example embodiments, instead of the user accessing the website for charging a vehicle by using the UE 4, a charging reservation application may be installed in advance in the UE 4 of a user and various types of operations, such as pressing down the charging waiting button or the transfer request button, may be performed through the application.

Further, in S130, S210, and S510, a user may enter a telephone number or an SNS account name instead of an email address. The email address, the telephone number, and the SNS account name are specific examples of the contact information.

Further, in the second example embodiment, the charging management unit 30 of the charging management server 2 transmits a unlock code to the email address of the second user 6b immediately after it registers the email address of the second user 6b (S320). However, a timing at which an unlock code is transmitted is not limited thereto, and an unlock code may be transmitted together with, for example, a notification that charging will be completed soon (S340) or a notification that charging is completed (S360).

Further, in the second example embodiment, when a vehicle is not parked in the standby space 3b, for example, five minutes before the charging management unit 30 of the charging management server 2 notifies the second user 6b that charging is completed, the charging management unit 30 of the charging management server 2 may automatically release the locked state of the charging unit 3 that has performed charging. By doing the above, the rate of operation of the charging unit 3 can be improved.

According to the present disclosure, a user who wants to use a charging unit after the current user of the charging unit can intentionally notify, by himself/herself, that he/she intends to use the charging unit to the current user.

The first to third example embodiments can be combined as desirable by one of ordinary skill in the art.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The whole or part of the example embodiments disclosed above can be described as, but not limited to, the following supplementary notes.

### (Supplementary Note 1)

A charging management server comprising:

a first acquisition unit configured to acquire contact information of a first user who uses a charging unit for charging a traction battery of a vehicle;

a first reception unit configured to receive a first request indicating that a second user wants to use the charging unit being currently used by the first user after the first user has finished using the charging unit, the second user being a user different from the first user; and

a first notification unit configured to notify the first user about the first request when the first reception unit receives the first request.

### (Supplementary Note 2)

The charging management server according to Supplementary note 1, wherein the first reception unit does not receive a new first request after it receives the first request while the first user is using the charging unit.

### (Supplementary Note 3)

The charging management server according to Supplementary note 1 or 2, comprising:

a second acquisition unit configured to acquire contact information of the second user; and

a second notification unit configured to notify the second user to start preparation to use the charging unit a first period of time before completion of the charging performed by the charging unit.

### (Supplementary Note 4)

The charging management server according to Supplementary note 3, further comprising a lock control unit configured to prohibit a user other than the second user from using the charging unit after the first user has finished using the charging unit.

### (Supplementary Note 5)

The charging management server according to Supplementary note 4, wherein the lock control unit prohibits a user other than the second user from using a charging space for using the charging unit, thereby prohibiting the user other than the second user from using the charging unit.

### (Supplementary Note 6)

The charging management server according to Supplementary note 4 or 5, wherein the lock control unit permits a user other than the second user to use the charging unit when the second user does not start using the charging unit during a period from when the second user is enabled to start using the charging unit to when a second period of time has elapsed.

### (Supplementary Note 7)

The charging management server according to any one of Supplementary notes 4 to 6, further comprising:

a second reception unit configured to receive a second request indicating that a third user wants to use the charging unit being currently used by the first user after the first user has finished using the charging unit, the third user being a user different from the first and the second users; and

a third notification unit configured to notify the second user about the second request when the second reception unit receives the second request,

wherein the lock control unit permits the third user to use the charging unit when the second user accepts the second request.

### (Supplementary Note 8)

The charging management server according to any one of Supplementary notes 1 to 7, wherein the first reception unit receives the first request only when a vehicle is present in a standby space that is provided adjacent to the charging space for using the charging unit.

### (Supplementary Note 9)

A charging system comprising: the charging management server according to any one of Supplementary notes 1 to 8; and a plurality of charging units.

### (Supplementary Note 10)

A charging management method comprising:
acquiring contact information of a first user who uses a charging unit for charging a traction battery of a vehicle;
receiving a first request indicating that a second user wants to use the charging unit being currently used by the first user after the first user has finished using the charging unit, the second user being a user different from the first user; and
notifying the first user about the first request when the first request is received.

### (Supplementary Note 11)

A program for causing a computer to function as the charging management server according to any one of Supplementary notes 1 to 8.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. A charging management server comprising:
a first acquisition unit configured to acquire contact information of a first user who uses a charging unit for charging a traction battery of a vehicle;
a first reception unit configured to receive a first request indicating that a second user wants to use the charging unit being currently used by the first user after the first user has finished using the charging unit, the second user being a user different from the first user; and
a first notification unit configured to notify the first user about the first request when the first reception unit receives the first request.

2. The charging management server according to claim 1, wherein the first reception unit does not receive a new first request after it receives the first request while the first user is using the charging unit.

3. The charging management server according to claim 1, comprising:
a second acquisition unit configured to acquire contact information of the second user; and
a second notification unit configured to notify the second user to start preparation to use the charging unit a first period of time before completion of the charging performed by the charging unit.

4. The charging management server according to claim 3, further comprising a lock control unit configured to prohibit a user other than the second user from using the charging unit after the first user has finished using the charging unit.

5. The charging management server according to claim 4, wherein the lock control unit prohibits a user other than the second user from using a charging space for using the charging unit, thereby prohibiting the user other than the second user from using the charging unit.

6. The charging management server according to claim 4, wherein the lock control unit permits a user other than the second user to use the charging unit when the second user does not start using the charging unit during a period from when the second user is enabled to start using the charging unit to when a second period of time has elapsed.

7. The charging management server according to claim 4, further comprising:
a second reception unit configured to receive a second request indicating that a third user wants to use the charging unit being currently used by the first user after the first user has finished using the charging unit, the third user being a user different from the first and the second users; and
a third notification unit configured to notify the second user about the second request when the second reception unit receives the second request,
wherein the lock control unit permits the third user to use the charging unit when the second user accepts the second request.

8. The charging management server according to claim 1, wherein the first reception unit receives the first request only when a vehicle is present in a standby space that is provided adjacent to the charging space for using the charging unit.

9. A charging system comprising: the charging management server according to claim 1; and a plurality of charging units.

10. A charging management method comprising:
a first acquisition step of acquiring contact information of a first user who uses a charging unit for charging a traction battery of a vehicle;
a first reception step of receiving a first request indicating that a second user wants to use the charging unit being currently used by the first user after the first user has finished using the charging unit, the second user being a user different from the first user; and
a first notification step of notifying the first user about the first request when the first request is received.

11. The charging management method according to claim 10, wherein in the first reception step, a new first request is not received after the first request is received while the first user is using the charging unit.

12. The charging management method according to claim 10, comprising:
a second acquisition step of acquiring contact information of the second user; and
a second notification step of notifying the second user to start preparation to use the charging unit a first period of time before completion of the charging performed by the charging unit.

13. The charging management method according to claim 12, further comprising a lock control step of prohibiting a user other than the second user from using the charging unit after the first user has finished using the charging unit.

14. The charging management method according to claim 13, wherein in the lock control step, a user other than the second user is prohibited from using the charging unit by prohibiting the user other than the second user from using a charging space for using the charging unit.

15. The charging management method according to claim 13, wherein in the lock control step, a user other than the second user is permitted to use the charging unit when the second user does not start using the charging unit during a period from when the second user is enabled to start using the charging unit to when a second period of time has elapsed.

16. The charging management method according to claim 13, further comprising:
a second reception step of receiving a second request indicating that a third user wants to use the charging unit being currently used by the first user after the first user has finished using the charging unit, the third user being a user different from the first and the second users; and
a third notification step of notifying the second user about the second request when the second request is received in the second reception step,
wherein in the lock control step, the third user is permitted to use the charging unit when the second user accepts the second request.

17. The charging management method according to claim 10, wherein in the first reception step, the first request is received only when a vehicle is present in a standby space that is provided adjacent to the charging space for using the charging unit.

18. A non-transitory computer readable medium storing a program for causing a computer to function as the charging management server according to claim 1.

19. A non-transitory computer readable medium storing a program for causing a computer to execute the charging management method according to claim 10.
